(19) United States
(12) Patent Application Publication
(10) Pub. No.: US 2015/0149257 A1
(43) Pub. Date: May 28, 2015

(54) SYSTEMS AND METHODS FOR ENTERPRISE PROFIT OPTIMIZATION

(71) Applicants: Andrew C. Bielat, Brush Prairie, WA (US); Mikhail I. Golovnykh, Lake Oswego, OR (US)

(72) Inventors: Andrew C. Bielat, Brush Prairie, WA (US); Mikhail I. Golovnykh, Lake Oswego, OR (US)

(21) Appl. No.: 14/091,205

(22) Filed: Nov. 26, 2013

(51) Int. Cl. G06Q 10/06

(52) U.S. Cl. CPC G06Q 10/0637
USPC 705/7.36

(57) ABSTRACT

Systems and methods that provide profit optimization and give manufacturers adequate information and object data for making capital and strategic sales, operational, and procurement decisions. Disclosed are embodiments for comprehensive machine-executable decision-making systems that provide executives with tools that identify the best possible plan to optimize profits. The systems and related components eliminate subjectivity, controversy, and confusion while supporting the natural workflow of the leadership team in the creation and execution of a single optimal plan.

### CROSS REFERENCE TO RELATED APPLICATIONS

This application claims the benefit of U.S. Provisional Application No. 61/731,124, filed Nov. 29, 2012, and having the same title and one of the inventors above.

### FIELD OF THE INVENTION

The present invention relates to systems, methods and apparatus for enterprise profit optimization using a combination of activity based costing techniques with linear programming analysis techniques. The present invention is particularly well suited to manufacturing processes yet may be applied to other fields as well.

### BACKGROUND OF THE INVENTION

Manufacturing is the production of goods for use or sale using labor and machines, tools, chemical and biological processing, or formulation. The term may refer to a range of human activity, from handicraft to high tech, but is most commonly applied to industrial production, in which raw materials are transformed into finished goods on a large scale. Such finished goods may be used for manufacturing other, more complex products, such as aircraft, household appliances or automobiles, or sold to wholesalers, who in turn sell them to retailers, who then sell them to end users—the “consumers”.

Modern manufacturing includes all intermediate processes required for the production and integration of a product's components. Some industries, such as semiconductor and steel manufacturers use the term fabrication instead.

Manufacturing executives lack the appropriate tools to make critical, complex operational and strategic decisions, and are instead forced to rely on incomplete mental models and antiquated spreadsheet practices. The result is suboptimal financial performance, failure to meet profit forecasts, friction between operations, sales and financial leadership, and impairment of shareholder confidence. Millions of dollars in profit are lost daily when manufacturers are forced to rely on inadequate information and subjective arguments for capital decisions and strategic planning.

These antiquated or inadequate practices include current costing and optimization practices. These practices may be limited in their individual scope or by their inherent shortcomings. They may also be limited by the failure of existing technologies to pull out selected features or combine particular features to more efficiently and effectively achieve profit optimization in manufacturing.

In addition, a frequent problem with optimization is the generation of “infeasible” outcomes based on erroneous input data or conflicting data. In large enterprises, the amount of input data may be vast, and it will be changing over time. Pre-optimization data investigation and adjustment to reduce or avoid “infeasible” outcomes is a need that exists in the field.

Various cost estimating or cost accounting methodologies are known in the art. These may be referred to as “costing” methodologies and include general ledger or conventional costing and activity based costing, among others. Accordingly to Wikipedia, November, 2013, activity based costing (ABC) is a costing methodology that identifies activities in an organization and assigns the cost of each activity with resources to all products and services according to the actual consumption by each. This model assigns more indirect costs (overhead) into direct costs compared to conventional costing. ABC typically provides reports and other user-friendly documentation that an entity may use for cost-based decision making.

The Chartered Institute of Management Accountants defines ABC as an approach to the costing and monitoring of activities which involves tracing resource consumption and costing final outputs. Resources are assigned to activities, and activities to cost objects based on consumption estimates. The latter utilize cost drivers to attach activity costs to outputs.

In a business organization, the ABC methodology assigns an organization's resource costs through activities to the products and services provided to its customers. ABC is generally used as a tool for understanding product and customer cost and profitability based on the production or performing processes. As such, ABC has predominantly been used to support strategic decisions such as pricing, outsourcing, identification and measurement of process improvement initiatives.

Following initial enthusiasm, ABC lost ground in the 1990s, to alternative metrics, such as Kaplan's balanced scorecard and economic value added. An independent 2008 report concluded that manually-driven ABC was an inefficient use of resources: it was expensive and difficult to implement for small gains, and a poor value, and that alternative methods should be used. Other reports show the broad band covered with the ABC methodology.

One relevant optimization process or tool is “linear programming,” also referred to as “linear optimization.” Linear optimization is a mathematical method for determining a way to achieve the best outcome (such as maximum profit or lowest cost) in a given mathematical model for some list of requirements represented as linear relationships. Linear programming is a specific case of mathematical programming (mathematical optimization).

More formally, linear optimization is a technique for the optimization of a linear objective function, subject to linear equality and linear inequality constraints. Its feasible region is a convex polyhedron, which is a set defined as the intersection of finitely many half spaces, each of which is defined by a linear inequality. Its objective function is a real-valued affine function defined on this polyhedron. A linear optimization algorithm finds a point in the polyhedron where this function has the smallest (or largest) value if such a point exists.

Linear optimization can be applied to various fields of study. It is used in business and economics, but can also be utilized for some engineering problems. Industries that use linear optimization models include transportation, energy, telecommunications, and manufacturing. It has proved useful in modeling diverse types of problems in planning, routing, scheduling, assignment, and design. As alluded to above, a substantial problem with linear programming in a complex, data-rich environment is the ability to investigate, adjust and/or correct the complex and potentially very large data sets to reduce or avoid outcomes in the “infeasible” region.

### SUMMARY OF THE INVENTION

The methods and apparatus of the present invention or “present solution” provide profit optimization that gives manufacturer adequate information and object data for making capital and strategic sales, operational, and procurement decisions. The present solution includes a comprehensive machine-executable decision-making system that provides executives with a tool that identifies, precisely, the best possible plan to optimize profits. It eliminates subjectivity, controversy, and confusion while supporting the natural workflow of the leadership team in the creation and execution of a single optimal plan. The present solution materially reduces the required effort to develop an operational plan and radically improves results, while empowering the team with precise performance expectations and pinpoint forecasting on demand. This allows the enterprise to focus all of its energy on the pursuit of the single best-possible profit plan. The executive, and the enterprise, are thus able to deliver on expectations of optimal and predictable profits.

The present solution provides a commercial-grade analytical system uniquely integrating powerful methodologies of activity based costing and linear optimization. The combination produces a simulation model with improved financial and operational accuracy. Complementary to existing client systems, the present solution leverages them to achieve the value expected from these systems at implementation. Any possible business scenario can be modeled and analyzed on demand, to identify and pursue the best possible profit plan.

In one embodiment, the present invention is implemented as software executing on a computing apparatus. This embodiment provides modeling capabilities for designing an “enterprise model” including a combination of processes and decision points. The processes and decision points are organized into a flow in such a way that the processes present various actions. One of the possible actions is the action of converting one set of products and/or materials to another set of products and/or materials. Other actions include actions of providing a value-added service, performing a business process, making a sale to a customer and receiving money for providing products/services.

The flow and decision points define which groups of products or services (ABC cost objects) require which processes in which order. The flow and decision points also define business opportunities resulting from doing one of: purchasing a product/service, making the product/service internally, or acquiring the product/service from another segment of the enterprise.

The enterprise model is constructed in such a way that the processes can be considered “activity-based costing” activities. Each process represented in the enterprise model can have multiple “activity-based costing cost elements.” One or more “activity-based costing drivers” can be associated with the processes, as well. The model is able to account for the majority of current enterprise costs and revenues, as well as for past and possible future enterprise costs and revenues. The model also allows processes to stand individually, outside the process flow, for accounting for the costs and activities that cannot be related to the processes in the flow.

The manufacturing or “enterprise” profit optimization solution also provides data management capabilities. Data is connected with corresponding models. The data includes lists of products and services, materials, categories, and groups. The data also includes financial data, such as costs of cost elements for processes and activities, which may be defined either in absolute numbers or in relative numbers. The data also includes prices of materials, values of recaptured scrap/effort, and constraints on elements, such as procurement volumes. Other types of data that are included are operations data, including yields, rates, routings and data captured from bills of materials, which provide for adding details to the flow, and constraints on elements, such as a number of hours or a time period during which a process will occur. Other data includes sales data. Multiple models and sets of data items may be collected and combined to provide a single model with the data items for a particular time period as a “scenario.”

The enterprise profit optimization solution also performs linear programming analysis to optimize profit. A linear programming optimization is performed over a scenario. The linear programming optimization is performing using a linear programming model constructed by the software from the enterprise model in combination with the data items on the fly. A user can identify one or more constraints to relax in the linear programming optimization problem, as well. For example, a user can choose to relax sales volumes of particular product groups, e.g. by 10%. The result of the optimization is a new scenario with optimal values for the relaxed parameters.

The enterprise profit optimization solution also provides specialized display functionality for presentation of results. Reports and dashboards are built and presented for individual scenarios in the form of industry standard activity-based costing reports, such as product bill of costs reports, customer profitability reports, product profitability reports, etc., as well as custom reports. Reports also allow for comparison of different scenarios to identify opportunities for improvement of the enterprise processes or to enable the understanding results of “what-if” analysis. One example of such “what-if” analysis is a comparison between results according to planned conditions and actual results that were realized.

The enterprise profit optimization solution provides a modeling capability supporting analysis using both activity-based costing and linear programming. The data management capability allows for management of multiple scenarios and for connecting data with the model. It is possible to differentiate between actual enterprise performance, planned enterprise performance, and, optionally, optimal enterprise performance given certain parameters relaxed and others constrained. The software product has the ability to generate an optimal profitability plan, including a proposed product mix, proposed sales strategy, proposed procurement strategy, and/or proposed capital expenditure allocations for the enterprise to adopt in order to realize optimized profit.

The software product also has the ability to generate a report comparing actual results to planned results, including the total difference in profitability between the actual results and the planned results, a pareto type list of products with the largest effect on profit caused by the variance in sales, and/or a pareto type list of products with the largest effect on profit caused by the variance in costs. The software product also has the ability to generate a product bill of costs report listing product costs for an individual product or product group according to activity based costing principles, additionally highlighting cost items significantly different from other products.

In one embodiment, the enterprise profit optimization solution operates with the use of data organized as “data tiles.” The software product defines ways to break data into a matrix, and each cell is named as a data tile. Data owners are assigned to data tiles, and data forms are generated for each data tile for editing. The data forms may be expressed in spreadsheet form, with the spreadsheets having columns for data from past periods, or averaged data.

These and related objects of the present invention are achieved by use of the methods and apparatus for manufacturing profit optimization as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1A is a block diagram depicting an embodiment of a network environment comprising client device in communication with server device.

FIG. 1B is a block diagram depicting a cloud computing environment comprising client device in communication with cloud service providers.

FIG. 1C is a block diagram depicting embodiments of computing devices useful in connection with the methods and systems described herein.

FIG. 2 is a block diagram depicting an embodiment of a system comprising a profit analyzer for optimizing profit of an enterprise.

FIG. 3 is a block diagram depicting a connection of a model to data for use in the profit analyzer of FIG. 2.

FIG. 4A is a process flow diagram depicting a steel manufacturing enterprise.

FIG. 4B is a process flow diagram depicting the steel mill of FIG. 4A.

FIG. 4C is a process flow diagram depicting the plate mill of FIG. 4A.

FIG. 4D is a process flow diagram depicting the pipe mill of FIG. 4A.

FIG. 5 is a flow diagram depicting an embodiment of a method of using the profit analyzer of FIG. 2 for optimizing profit of an enterprise.

FIG. 6 is a screenshot of an embodiment of a report showing profitability by customer according to a scenario optimized by the profit analyzer.

FIG. 7 is a screenshot of an embodiment of a report showing a comparison of revenue, cost and profit between two scenarios optimized by the profit analyzer.

FIG. 8 is a screenshot of an embodiment of a report showing an optimized sales plan resulting from optimization of a scenario by the profit analyzer.

### DETAILED DESCRIPTION

The description is divided into two sections. Section A describes a networking and computing environment for the present invention. Section B describes machine executable systems or methods for enterprise profit optimization.

### A. Computing and Network Environment

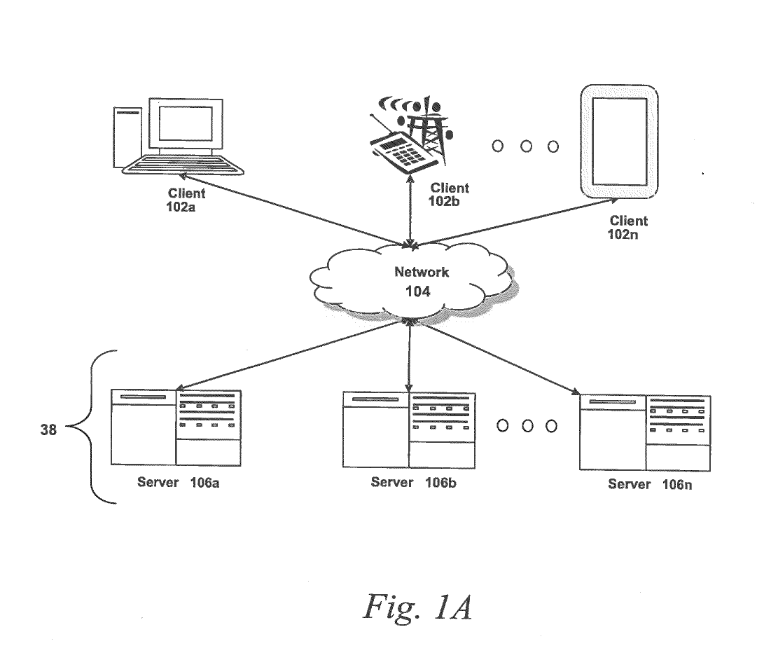

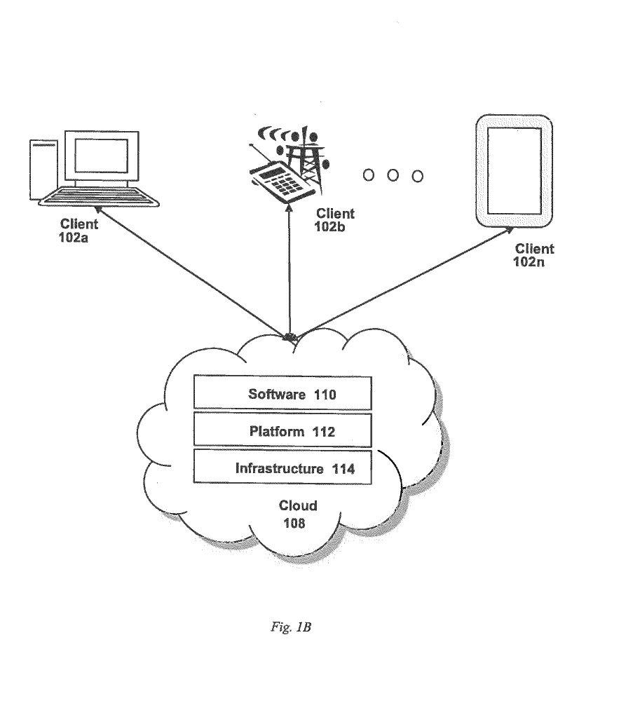

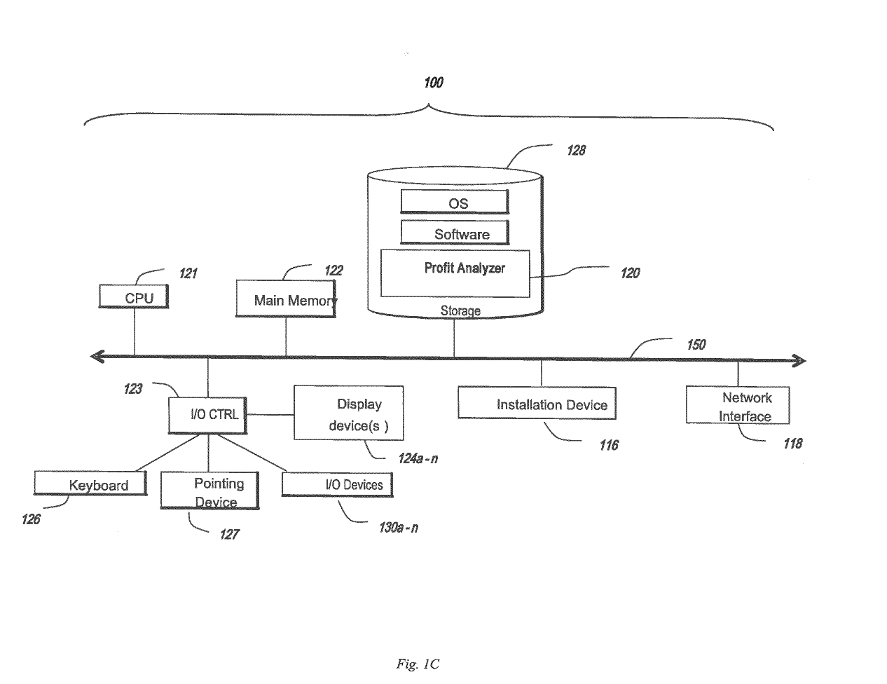

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines, or other. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by the ITU (International Telecommunication Union). The network 104 may be any type and/or form of network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection, or other.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may also include a cloud based delivery, e.g. Software as a Service (SaaS) 110, Platform as a Service (PaaS) 112, and Infrastructure as a Service (IaaS) 114, or other. These services are known in the art.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIG. 1C depicts a block diagram of a computing device 100 useful for practicing an embodiment of the client 102 or a server 106. As shown in FIG. 1C, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a profit analyzer 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121. Suitable processing and computing apparatus are known in the art.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Profit Analyzer

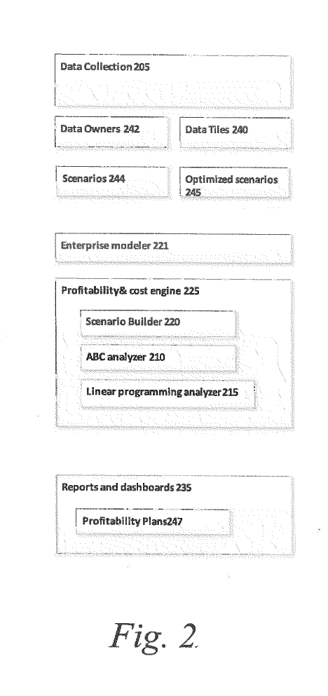

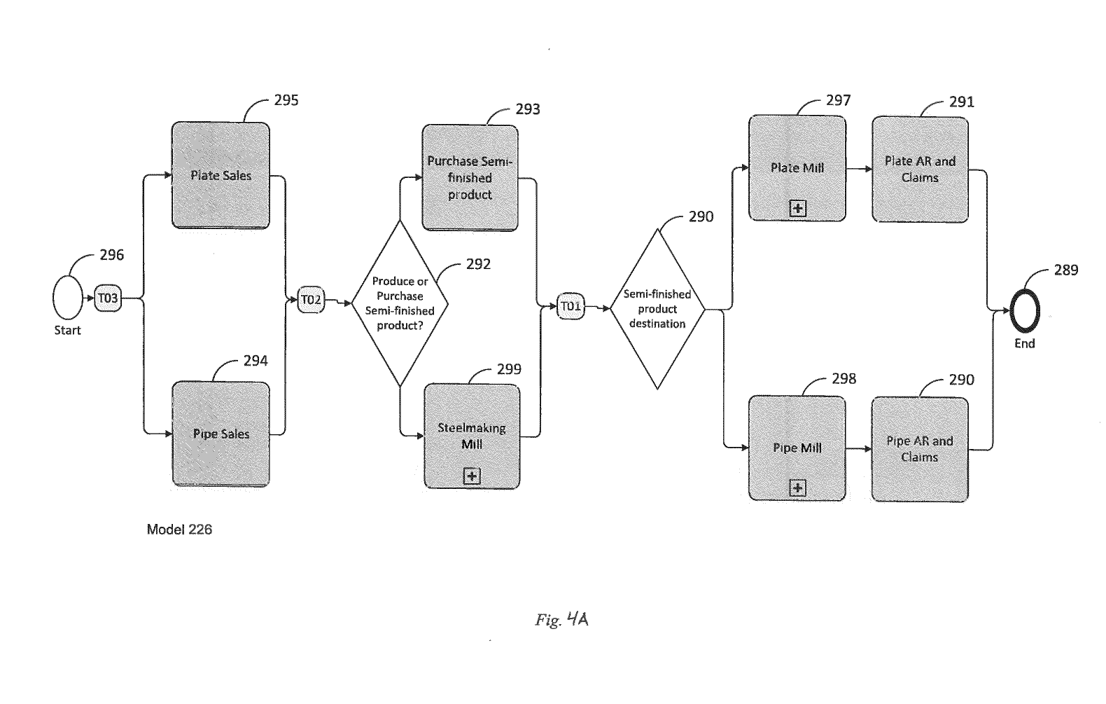

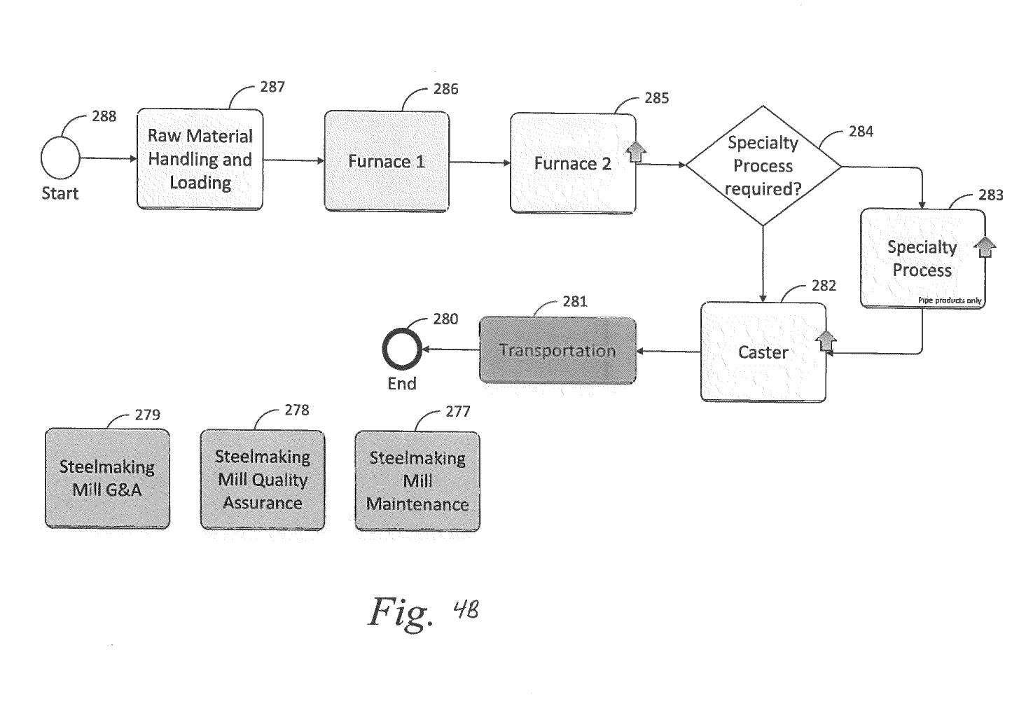

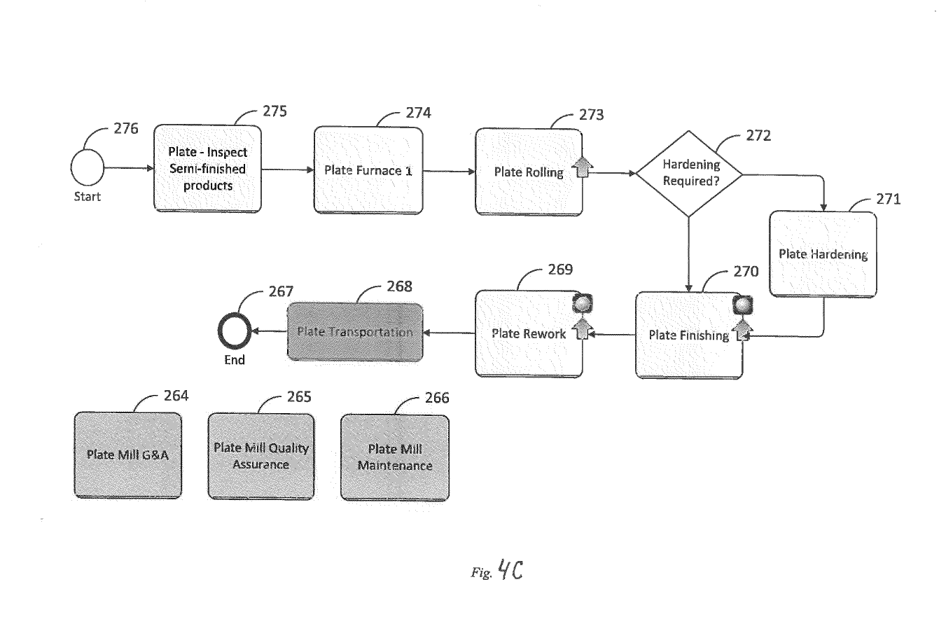

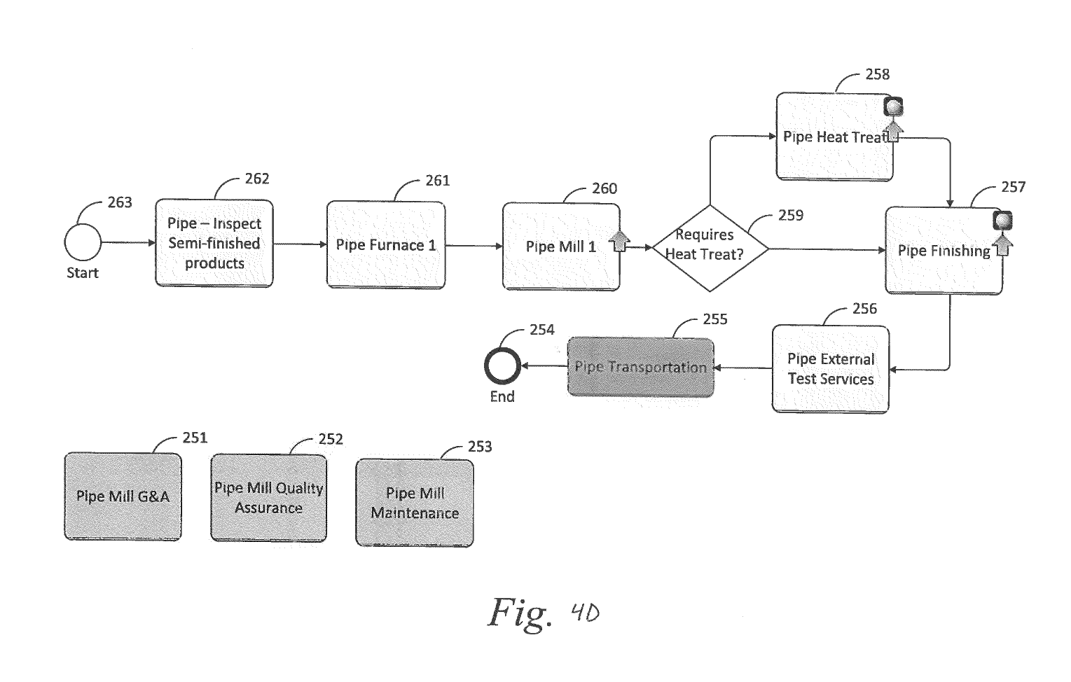

Systems, methods and apparatus of the present solution are directed to a profit analyzer which will be described in connection with FIGS. 2,3, and 4A-4D, among others. An exemplary profit analyzer for optimizing enterprise profit in accordance with embodiments of the present solution is illustrated with reference to FIG. 2. One example of an enterprise that can be modeled and optimized for profit, as is shown in detail below in FIGS. 4A-4D, is a manufacturing enterprise for selling, manufacturing and delivering steel raw materials and finished manufactured parts. FIG. 4A is a process flow diagram of one such exemplary manufacturing enterprise. FIG. 4B is a process flow diagram corresponding to steelmaking mill 299 of FIG. 4A. FIG. 4C is a process flow diagram corresponding to plate mill 297 of FIG. 4A. FIG. 4D is a process flow diagram corresponding to pipe mill 298 of FIG. 4A.

Referring now to FIG. 2, an embodiment of a system for an enterprise profit optimization, referred to as the profit analyzer 120, is depicted. In brief overview, a client 102 is in communication via a network 104 with a server 106 that executes a profit analyzer 120. The profit analyzer 120 provides a combination of activity based costing with linear programming (introduced above in the Background of the Invention section) via a profitability and cost engine 225 that has a scenario builder 220, an activity-based costing analyzer 210, and a linear programming analyzer 215. The data collection 205 module of the profit analyzer may obtain a model 226, such as ABC model, and corresponding data 206 from a device, such as the client.

In one example, data 206 may be provided by client 102 in the form of a spreadsheet. In other examples, data 206 may be provided in other ways, such as via queries to a database or a comma-separated values (CSV) file. The data collection 205 may organize the data 206 into data tiles 240 with portions of the data owned by assigned data owners 242. The scenario builder 220 may organize the data with the model into scenarios 244 and optionally define optimization criteria for optimized scenarios 245. The ABC analyzer 210 may process the data 206 and model 226 (optionally through a scenario 245) to generate activity based costing specific and custom profitability and cost reports, as well as data for use by dynamic dashboards. The linear programming analyzer 215 provides optimized scenarios and profitability plans.

The profit analyzer 120 includes an enterprise modeler 221 for modeling an enterprise into an activity based costing model allowing linear programming optimization. The enterprise modeler may comprise an application, program, library, process, service, task or any type and form of executable instructions executable on a device. The enterprise modeler may be designed and constructed to model an enterprise's operations, such as manufacturing, sales, and general and administrative functions in to an ABC model. One exemplary application that may be used for the enterprise modeler is Microsoft Visio. In other embodiments, other project-diagramming software may be used off-the-shelf or custom-designed in-house by the enterprise. A user of the enterprise modeler can create a visual representation of process and decision flows in the form of, e.g., a conventional flow chart. The user adds shapes, connectors, labels, and other metadata to the project workspace provided by the enterprise modeler to construct a flow diagram representing processes that are performed as part of the business enterprise. In some embodiments, the visual representation of the process and decision flows may be generated according to a modeling design standard for business process models, such as Business Process Model and Notation (BPMN). Other embodiments may use other modeling standards. For example, a user may employ flowcharting techniques such as activity diagrams from Unified Modeling Language (UML). Other exemplary business process modeling techniques that may be used include Cognition enhanced Natural language Information Analysis Method (CogNIAM), Extended Business Modeling Language (xBML), Event-driven process chain (EPC) and ICAM DEFinition (IDEF0). The BPMN specification also provides a mapping between the graphics of the notation and the underlying constructs of execution languages, particularly Business Process Execution Language (BPEL). Accordingly, the BPMN-based model diagrams may be suited to automatic processing when provided to external software modules.

The data collection or collector 205 comprises a module and/or interface for obtaining a model 226 and data 206 for the profit analyzer. The data collector may comprise an application, program, library, process, service, task or any type and form of executable instructions executable on a device. The data collector 205 may be designed and constructed to file transfer, retrieve, upload or otherwise obtain a data 206 and/or model 226. The data collector may have an application programming interface (API) to obtain the model 226 and data 206 stored on a client 102. Data collector 205 also may retrieve model 226 and/or data 206 from a database stored on a device, via, e.g., a structured query language (SQL) request. Data collector 205 may also be associated with an Internet address or Uniform resource locator (URL), such that client 102 can access the Internet address or URL and push data to data collector 205 at the client's demand. In other embodiments, data collector 205 may send a periodic request to client 102 to determine if any new information has been queued at client for transfer to data collector.

The data 206 comprises any type and form of data representing operational and/or performance data of an enterprise in connection with a model and/or executing the profit analyzer. The data may be in any type and format, such as an excel spreadsheet, a Comma Separated Values (CSV) file, a relational database, a text file, etc. The data includes numerical values relating to costs, revenues, prices, ingredients and prerequisites for business processes and manufacturing processes, production rates, and so on. For example, the data may include costs of raw materials for a steelmaking process, costs of purchasing semi-finished steel products for use in a manufacturing finishing process that the business enterprise does not make itself, costs of transporting materials, costs of labor, etc. The data may include total contract prices for fulfilling certain customer orders, etc. In the context of the example steel mill manufacturing described herein, the data may include sale prices per pound of produced steel product. The data may include lists of ingredients required for making each ton of high quality steel, and ingredients for making a lower quality ton of steel. The data may include lists of prerequisites for making a ton of high quality steel, e.g., how many pounds of which raw materials, how much time in a furnace at a particular temperature, cost of energy to power furnace, how many workers are required for how much time to execute the process, and so on. The data may include a total maximum or average output of a particular furnace in a steelmaking mill in tons of high quality steel per hour, tons of lower quality steel per hour, etc.

The data 206 provides values for items identified or included in the model 226. The model may comprise meta-data or attributes for the model. The data may provide the actual values for the meta-data or attributes identified in the model when performing profit analysis as described herein. For example, a manufacturing process of model 226 may indicate that steelmaking requires raw ingredients, labor, and steelmaking time, and that raw ingredients, labor and steelmaking each incur certain costs, such as ingredient prices, worker hourly wages, and energy costs associated with the process of steelmaking. Data 206, correspondingly, may define specific values to each of these costs to be used in generating a scenario. The data values can be linked to elements in the model in various ways. For example, the data values may be represented in a spreadsheet having unique column and/or row identifiers, while the model includes metadata relating to the processes and is also represented in a spreadsheet having unique column and/or row identifiers. In such a case, the data and model can be connected according to shared column and/or row identifiers that are identical in the spreadsheet corresponding to the data and in the spreadsheet corresponding to the metadata of the model. In other embodiments, the model may include an archetypal list of all kinds of metadata that each process or decision in the flow diagram may have associated with it. The data could then be connected to the model by means of a logical pair wise association, such as <process_name, metadata_field>. Thus, for example, one such unique identifier might be <steelmaking_mill_furnace_{—}1, time_to_produce_{—}1_ton>. A spreadsheet of data 206 could include a row entitled “steelmaking_mill_furnace_{—}1,” and a column entitled “time_to_produce_{—}1_ton,” with a numerical value, such as “60 minutes” in the cell at those coordinates. Upon linking the model to the data, the value “60 minutes” would then be linked to the first furnace of the steelmaking mill as being the amount of time required to produce a ton of steel.

The profit analyzer may process data into data tiles 240. Data 206 is broken into a matrix, and the cells of the matrix are referred to as data tiles 240. A data tile includes a subset of the data 206 that is grouped into a single logical unit. For example, information relating to a particular subprocess (e.g., plate mill 297 of FIG. 4A) may be grouped into a data tile. In the example of the plate mill, which is described below with reference to FIG. 4C, the data tile may then include data regarding costs of operating the plate furnace, production rates realizable during plate rolling, intervals at which plate mill quality assurance is to be performed, and so on. Data tiles 240 may be stored in memory or disk, such as transient memory, disk storage, flash memory, etc. in the form of digital files. Data tiles 240 may comprise binary data, spreadsheet data, relational database tables, etc.

The profit analyzer may also assign and manage information regarding data owners 242. At least one of client 102 and profit analyzer can assign data owners 242 to data tiles and generate data forms for use in editing each data tile. The data forms may be expressed in spreadsheet form, in which the columns may correspond to data from past periods and/or averaged data. The information regarding data owners 242 may be stored separately as a master directory of the relationships between data owners and their respective data tiles. Using data tiles with data owners, an enterprise can assign the appropriate persons to provide and manage respective data of certain portions of the enterprise. Different data owners may be able to access and view the data for the enterprise but only data owners with granted permission can edit certain portions of the enterprise data, such as one or more cells of a matrix for a data tile assigned to the data owner.

The model 226 may comprise one or more data structures and/or logical constructs, such as a block or flow diagram, that represents the processes that a business enterprise performs, the decisions the business enterprise makes in execution of the enterprise objectives, and the costs (and profit) that are associated with these processes and decisions. The model may be designed and constructed via a modeling tool 221 such as Visio. The modeling tool may include templates designed and constructed to meet the format and data requirements of the profit analyzer. The model may include any design elements, constructs, meta-data or attributes that support, define or identify various ABC elements, such as types of fixed costs associated with a process, types of variable costs associated with a process that vary contingent on decisions made earlier in the process flow, prerequisites for performing the process, and so on. For example, a modeled process of making steel may require a certain set of raw ingredients (i.e., a prerequisite), which varies based on which kind of steel is being made (which may be the result of an earlier business decision), and may involve a certain fixed cost (e.g., annual cost of insurance or labor costs at the steel mill).

In some embodiments, there is a visual representation of the process and decision flows which may be made according to a modeling design standard for business process models, such as Business Process Model and Notation (BPMN). Other embodiments may use other modeling standards. For example, a user may employ flowcharting techniques such as activity diagrams from Unified Modeling Language (UML). Other exemplary business process modeling techniques that may be used include Cognition enhanced Natural language Information Analysis Method (CogNIAM), Extended Business Modeling Language (xBML), Event-driven process chain (EPC) and ICAM DEFinition (IDEF0). The BPMN specification also provides a mapping between the graphics of the notation and the underlying constructs of execution languages, particularly Business Process Execution Language (BPEL). Accordingly, the BPMN-based model diagrams may be suited to automatic processing when provided to external software modules.

Profitability and cost engine 225 includes a scenario builder 220. Scenario builder 220 aggregates model 226 and data 206 into a scenario having values including parameters and constraints that can be provided as input for a linear programming analysis. In some implementations, existing scenarios may be modified to create new scenarios by, e.g., adjusting one or more constraints. In one example, sales volumes of one or more product groups may be relaxed, e.g., by 10%. Alternative scenarios such as these can then be used for comparison purposes to determine the potential consequences of different events, such as a drop in sales from expected figures. Use of different scenarios can allow for differentiating between actual enterprise performance and planned enterprise performance, and also enterprise performance when certain parameters are relaxed and others constrained.

Profit analyzer 120 also includes a linear programming analyzer 215 for performing an analysis on a model and data via a scenario using one or more analysis techniques, such as linear programming analysis. The analyzer may comprise an application, program, library, process, service, task or any type and form of executable instructions executable on a device. The analyzer may be designed and constructed to apply an analysis technique to a scenario based on the model and data to determine an optimized scenario to and/or profitability plan. In some embodiments, the linear programming tool may comprise Microsoft Solver. Numerous other commercial or free open-source software applications may be used for solving linear programming optimization problems, including OpenOpt, LP_Solve, CPLEX, MATLAB and Mathematica. A linear programming software application may be chosen, e.g., based on what APIs it supports, what operating system platforms it supports, whether it supports mixed-integer optimization, and so on. The linear programming tool may be designed and constructed to perform a mathematical optimization of a linear objective function, subject to linear equality and linear inequality constraints.

In operation, the profitability and cost engine 225 receives inputs including at least one enterprise model 226 modeling the process flows and decision points of an enterprise, which can include both business-related activities, such as sales and quality assurance, and manufacturing processes such as steelmaking. The profitability and cost engine 225 also receives data items for a particular time period 206 The linear programming analyzer 215 receives inputs including a scenario provided by scenario builder 220. Analyzer 215 performs a linear programming optimization over the provided scenario, thereby generating one or more optimized scenarios 245. An optimized scenario includes parameters that have been determined by analyzer 215 to maximize or minimize an objective function corresponding to the scenario. Exemplary objective functions that may be chosen for maximization may include gross revenue, net profit, and total sales. Similarly, exemplary objective functions that may be chosen for minimization may include materials costs, labor costs, and time to completion (e.g., for production of a certain set of products). The optimized scenario may thus indicate suggested values for parameters, such as production volumes of specific products at specific plants, that, when implemented subject to the defined constraints, such as available production capacity and time to delivery, can be expected to result in an optimal value of the objective function (e.g., maximum profit).

Profit analyzer 120 also produces and presents reports and dashboards based on scenarios 244, 245. One such report may be a profitability plan 247. Profitability plan 247 includes profitrelated results of a selected scenario, such as sales volumes, revenues, costs, operating profit and unit profit for one or more products. An optimal profitability plan constructed for an optimal scenario may include a suggested product mix and/or sales strategy and/or procurement strategy and/or capital expenditure allocations.

Profit analyzer 120 also includes a reports and dashboards 235 that provides access to various reports derived from scenarios 244 and 245 processed by ABC analyzer 210 and linear programming analyzer 215. For example, dashboards and reports 235 may provide industry standard activity-based costing reports, including, e.g., a product bill of costs, customer profitability and product profitability. Reports and dashboards 235 also may include custom reports and custom dashboards, which may provide static and/or dynamic presentations of the information. Reports and dashboards 235 also may allow a user of profit analyzer 120 to compare scenarios to understand opportunities or understand results of what-if analysis, such as a comparison between a planned scenario and an actual scenario reporting, e.g., the total difference in profitability between the actual observed profit and the expected profit according to a previously-calculated optimized planned profit. The reporting also may include a pareto type list of products with the largest effect on profit caused by a variance in sales, and/or a pareto type list of products with the largest effect on profit caused by a variance in costs. A product bill of costs report may list product costs for an individual product or product group as may be performed in activity-based costing, additionally highlighting cost items significantly different from other products.

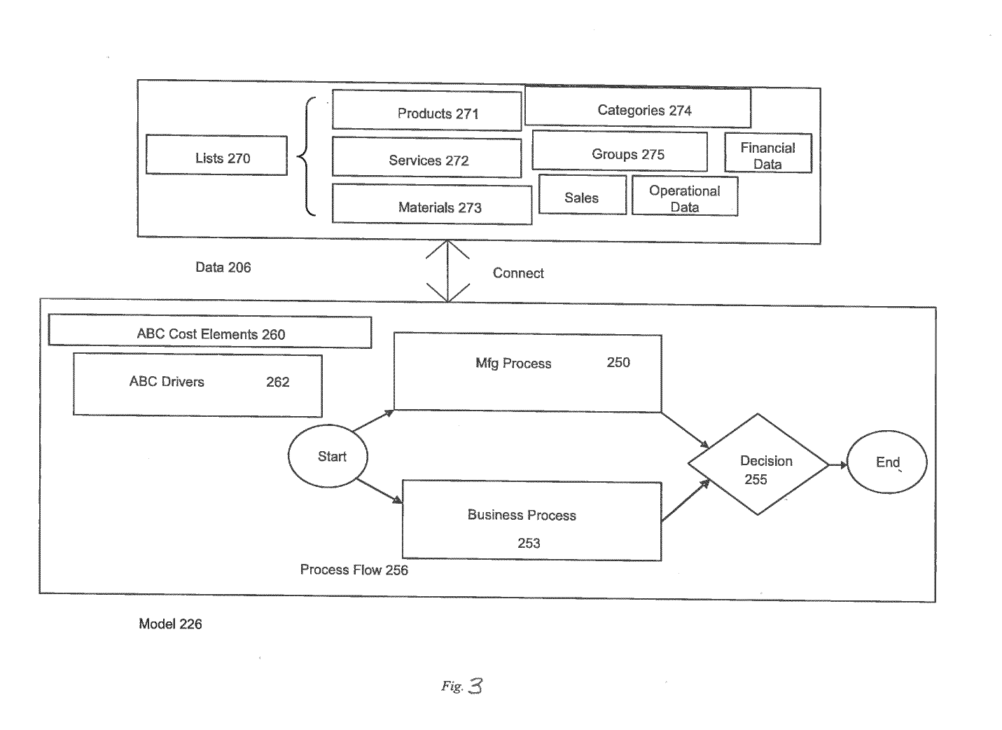

Referring now to FIG. 3, an embodiment of data 206 connected with a model 226 is illustrated. In brief overview, the model 226 comprises a process flow 256 with a start and an end point or block. The model may include manufacturing processes 250 in combination with business processes 253 that flow through one or more decision points 255. ABC modeling constructs such as ABC Cost elements 260 and ABC drivers 262 may be identified in the manufacturing and business process blocks of the model. Data 206 may be associated with or connected with the model 226 to provide data for running the model. The data may include lists 270 of information and corresponding data, such as for products 271, services 272, materials 273, categories 274 and groups 275, such as yields by product by process, production rates by product by process, sale of individual and/or groups of products to customers, prices of materials, and other types of operational, financial, production, and sale data.

The reporting may also include Performance Index, Achievement Index, Creativity Index, or a combination of the three—representing the business intelligence quotient of the enterprise. These indexes are normally calculated for scenarios containing actual data of the enterprise (actual scenarios). The higher these indices the more agile, creative and successful the enterprise will be.

Performance Index is calculated as the actual scenario's bottom-line (total) profit divided by the total profit of the actual scenario for a period designated as the base period.

Achievement Index is calculated as the actual scenario's total profit divided by the total profit of the optimal scenario for this same period (scenario with constraints relaxed). Creativity Index is calculated as the total profit of the optimal scenario divided by the total profit of the optimal scenario for the base period.

Creativity Index can also be calculated as (total profit of the optimal scenario/total profit of the actual scenario)/(total profit of the optimal scenario for the base period/total profit of the actual scenario for the base period).

The system allows the user to identify which scenarios contain the actual data, which scenarios should be considered optimal, which scenarios are to be considered plan, and which period(s) are to be used as the base periods. The reporting displays Performance Index, and/or Achievement Index, and/or Creativity Index per individual scenarios, as well as in a trend form. These indexes provide the enterprise leaders with a different perspective on the performance of the enterprise and can be used as independent measures as well as together with standard financial and operational metrics calculated by the system.

As the business practice, the indexes can also be calculated over non-actual scenarios. For example, market-adjusted scenarios containing expected prices of materials and product pricings instead of actual.

The model 226 includes a process flow 256. Process-flow 256 proceeds from the start to various processes that may occur in parallel, including at least manufacturing process 250 and at least one business process 253. Process-flow 256 thus can model an entire enterprise, by incorporating both kinds of processes, modeled such that the processes can be considered activity-based costing activities. Each process can have multiple activity-based costing cost elements defining the associated costs, as well as multiple activity-based costing drivers. The model can account for the majority of current enterprise costs and revenues, as well as past and possible future enterprise costs and revenues. Process-flow 256 also leads to at least one decision 255 that is made after at least one of the manufacturing processes 250 and/or business processes 253. Process flow and decision points in model 226 can define which groups of products or services (e.g., activity-based costing objects) require which processes in which order. The process flow may be created by a user of the ABC modeler to provide a visual representation of process and decision flows in the form of, e.g., a flow chart. The process flow 256 comprises shapes, connectors, labels, and other metadata making up a flow diagram representing processes that are performed as part of the business enterprise. In some embodiments, the visual representation of the process and decision flows may be generated according to a modeling design standard for business process models, such as Business Process Model and Notation (BPMN), Unified Modeling Language (UML), Cognition enhanced Natural language Information Analysis Method (CogNIAM), Extended Business Modeling Language (xBML), Event-driven process chain (EPC) and ICAM DEFinition (IDEF0).

The process flow 256 may include at least one manufacturing process 250. Manufacturing processes may include processes involving conversion of raw materials into processed materials, such as making steel. Manufacturing processes also may include working of semi-finished processed materials into other intermediary materials, such as rolling newly made steel into sheet metal. Manufacturing processes also may include processes intermediate materials into highly worked final products ready for packaging and delivery to a customer, such as working of steel into pipes.

The process flow 256 also includes at least one business process 253. The process flow may be used to model any type and form of business process separate and distinct from any manufacturing processes. Business processes may include processes such as marketing, sales, fulfillment, negotiating contracts, general administrative functions, performing quality assurance reviews, and so on. A business process also could include collections processes to receive and process payments for products and services.

The process flow 256 may also include decision point 255 in the process flow. The decision determines, at a particular point in the process flow 255, which of at least two possible processes, is performed next after the decision point, on the basis of a business decision made for the enterprise. For example, when there are two or more possible sources for input materials to be used in a manufacturing process, a decision 255 must be made of which to use. For example, in FIG. 2C (discussed in detail below), a semi-finished product may be sent either to plate mill 297 or pipe mill 298, and a decision must be made where to send the material. Also in FIG. 2C, it can be seen how a decision point ties together business processes and manufacturing processes into a single model. At decision point 292, a decision must be made as to whether to purchase the semi-finished product for later use in the pipe mill/plate mill, or whether to produce the semifinished product within the enterprise. In the first case, the business process 293 of purchasing the semi-finished product is performed, whereas in the second case, the manufacturing process of manufacturing the semi-finished product at the steelmaking mill 299 is performed.

A scenario being analyzed by the profit analyzer may be performed on data identified by any one or combination of a product, service, material category or groups. Individual data items of the data 206 may be linked to the model by being associated with a process in the model 226, and also may be associated with a product or product group in addition to the process. Data 206 may include financial data, such as costs of cost elements for processes or activities, which may be defined in absolute numbers and/or relative numbers. Financial data also may include prices of materials (e.g., raw ingredients required for making steel), value of recaptured scrap/effort, and constraints on elements, such as procurement volumes. Data 206 also may include operations data, such as yields of manufacturing processes, rates of production, routings and Bills of Materials (providing means to add details to the flow), and constraints on elements, such as an allotted number of hours or specified time period. Data 206 also may include sales data.

Model 226 may be designed to be an enterprise model including a combination of processes and decision points organized into a flow. As an enterprise model, model 226 can model a variety of processes that make up the activities of an enterprise. The processes may describe one or more actions, which can be modeled according to principles of activity-based costing, and thus each will have certain associated, individually modeled costs. Such actions may include converting one set of products and/or materials into another set of products and/or materials, such as steelmaking from raw materials, casting and/or rolling the steel, and manufacturing plate and pipe products from the processed steel. Other actions may include value-added services, such as providing products in a custom packaging for a customer for an extra cost. Other actions may include business processes, such as performing a quality assurance review or audit. Other actions may include selling products and services to customers, which may incur overhead costs in the sales process. Yet further actions may include receiving money from customers for products and/or services, which may include costs such as collections costs. Model 226 may include cost elements 260 for activity-based costing. In some embodiments, the cost elements are identified or associated with specific steps in the process flow, for a manufacturing and/or process flow. In some embodiments, while manufacturing processes and business processes include costs, an enterprise model also may account for cost elements that are not explicitly associated with a particular process in the process flow. For example, in FIG. 2D, discussed below, steelmaking mill G&A 279, steelmaking mill quality assurance 278, and steelmaking mill maintenance 277 are cost elements that stand on their own, outside of the process flow. Such cost elements 260 may correspond to costs that are incurred on a regular basis, such as daily, monthly, and yearly overhead costs, like rent, electricity for lighting, insurance, labor, etc.

Model 226 may also include drivers 262 for activity-based costing. The drivers may identify the unit of cost that causes changes in cost for an activity. The drivers may be for example, amount of hours or time, volume of use, time of use, etc. In some embodiments, such drivers 262 may activities that indirectly cause costs to be incurred. Some examples of indirect costs and their drivers are: indirect costs for maintenance, with the possible driver of this cost being the number of machine hours, or the indirect cost of handling raw-material cost, which may be driven by the number of orders received, or, inspection costs that are driven by the number of inspections or the hours of inspection or production runs.

Referring now to FIGS. 4A-4D, examples of a model 226 are depicted. Model 226 includes a flow diagram representing a business and manufacturing cycle of a manufacturing enterprise. The flow starts at element 296. The start 296 connects to two business processes, plate sales 295, and pipe sales 294, which may occur in parallel. The flow continues at decision block 292, representing the business decision of whether to produce the semi-finished product that is to be used in manufacturing the final product that was sold, or whether to purchase the semi-finished product. If the enterprise makes the business decision to purchase, the flow continues to business process 293, where the semi-finished product is purchased. If, on the other hand, the enterprise makes the business decision to produce the semi-finished product, the flow continues to subprocess 299, corresponding to the enterprise's steelmaking mill. The operation of subprocess 299 is discussed below with reference to FIG. 4B. The flow continues at business decision 290, at which the enterprise decides what the destination for the semi-finished product is to be. The semi-finished product (e.g., rolled steel sheet metal) is then routed, on the basis of business decision 290, to one of two subprocesses corresponding to plate mill 297 or pipe mill 298, which are discussed below with reference to FIGS. 4C and 4D, respectively. The flow continues to accounts receivable (AR) and claims. From plate mill 297, the flow continues to plate AR and claims 291, whereas from pipe mill 298, the flow continues to pipe AR and claims 290. In either case, the process flow concludes at element 289.

An exemplary subprocess corresponding to steelmaking mill 299 of FIG. 4A is now discussed with reference to FIG. 4B. A process flow diagram begins at element 288, and proceeds to business process 287, where raw materials are handled and loaded to provide them, successively, to a first furnace 286 of the steelmaking mill and a second furnace 285 of the steelmaking mill. The process flow continues at business decision 284, where the enterprise determines whether a specialty process 283 is required for manufacturing the particular product that is being manufactured. After optional specialty process 283, the process flow continues at caster process 282 where solid steel is produced. The flow continues at process 281 where the semi-finished product is transported from the steel mill to its next destination, and the process flow finishes at element 280. Independent processes also are shown as part of the process flow of FIG. 4B, corresponding to steelmaking mill maintenance 277, steelmaking mill quality assurance 278, and steelmaking mill general and administrative expenses 279. Each of these processes also make up part of the activity-based costing model by modeling certain costs independently of the specific business and manufacturing processes in the flow just described.

An exemplary subprocess corresponding to plate mill 297 of FIG. 4A is now discussed with reference to FIG. 4B. A process flow begins at element 276 and proceeds at process 275, where semi-finished products (received from the steelmaking mill just described, or purchased from a third party) are inspected. The flow continues as the semi-finished products are provided to the plate furnace 274. The results of this process are provided to the plate roller 273. The flow continues at business decision 272, where it is determined whether hardening is required, in which case the plate hardening process 271 is performed. Thereafter, the plate is finished at process 270, reworked at process 269, and transported from the plate mill to its next destination at process 268. The process flow ends at element 267. Independent processes also are shown as part of the process flow of FIG. 4B, corresponding to plate mill maintenance 266, plate mill quality assurance 265, and plate mill general and administrative expenses 264.

Each of these processes also make up part of the activity-based costing model by modeling certain costs independently of the specific business and manufacturing processes in the flow just described.

An exemplary subprocess corresponding to pipe mill 298 of FIG. 4A is now discussed with reference to FIG. 4D. A process flow begins at element 263 and proceeds at process 262, where semi-finished products (received from the steelmaking mill just described, or purchased from a third party) are inspected. The flow continues as the semi-finished products are provided to the pipe furnace 261. The results of this process are provided to the pipe mill 260. The flow continues at business decision 259, where it is determined whether heat treatment is required, in which case the pipe heat treating process 258 is performed. Thereafter, the pipe is finished at process 257, tested at process 256, and transported from the pipe mill to its next destination at process 255. The process flow ends at element 254. Independent processes also are shown as part of the process flow of FIG. 4D, corresponding to pipe mill maintenance 253, pipe mill quality assurance 252, and pipe mill general and administrative expenses 251. Each of these processes also make up part of the activity-based costing model by modeling certain costs independently of the specific business and manufacturing processes in the flow just described.

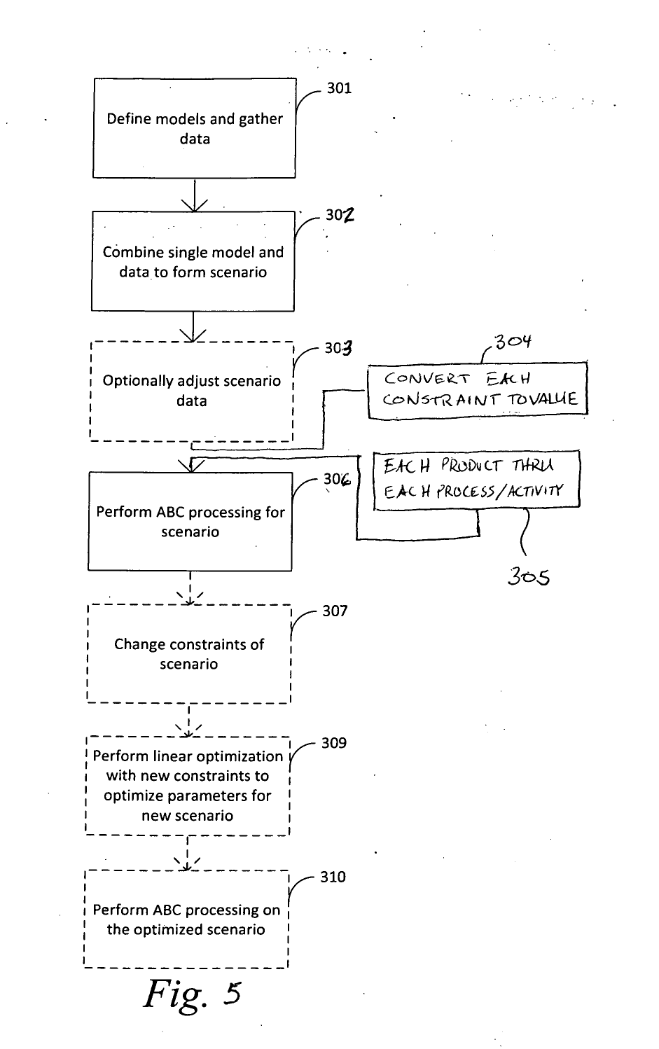

Referring to FIG. 5, an embodiment of a method for analyzing profit via the enterprise profit optimization in accordance with the present invention is now described.

In brief overview of the method, at step 301, models for the enterprise are defined, and operational data are gathered. At step 302, a single model is combined with the operational data to form a scenario. At step 303, some of the data is optionally modified by the user to arrive at a modified scenario. At step 304, each constraint is given or “converted to” an initial value in preparation for ABC1. At step 305, assurance is made that each product is run through all processes/activities in respective paths, so that appropriate data is gathered for all products and activities input to ABC1. At step 306, a first activity based costing processing (ABC1) is executed to produce profitability and cost reports and dashboards for the scenario or modified scenario, exposing what-if profitability results for the enterprise. At step 307, one or more constraints of the scenario are changed, if desired. At step 309, linear optimization is performed on the output ABC1 in accordance with the defined constraints. At step 310, a second activity based costing processes (ABC2) is executed on post optimization data to produce reports and dashboards that permit a user to make strategic decision that will implement the profit optimization product of the LP process. The output of ABC2 may include what-if profitability results for the enterprise on “feasible” optimization outcomes. The reports and dashboards of ABC are generally known in the art.

In further details of step 301, a model for the enterprise is defined. The model may be defined by a user operating on behalf of the enterprise. In some embodiments, the model may be defined externally to the enterprise, e.g., by an external business consultant, as a result of analyzing the enterprise, and the model may then be received at the system. The model may be defined by the user using a graphical project modeling tool such as Microsoft Visio. The user can add shapes, connectors, labels and metadata to the project workspace to create one or more process flow diagrams representing business and manufacturing processes of the enterprise, decision points in the process flow, internal and external cost drivers relating to the processes in the process flow, and cost elements of the enterprise that stand inside or outside of the defined process flow. In some embodiments, multiple models may be defined according to different accounting principles, by different individuals designing the models, etc., which may allow for greater certainty and flexibility in evaluating the enterprise by presenting the opportunity to compare the results of the optimization processes under multiple models. In other cases, the different models may be used to present different scenarios representing fundamental changes to the enterprise that may be undertaken, such as buying or selling a new factory.

In still further details of step 301, operational data for the enterprise is gathered. The data may be automatically or manually gathered. Automatic data gathering may include receiving data relating to profits and revenues from automated systems monitoring sales information (e.g., total sales recorded over a period of time for a particular product), and observed production data from manufacturing processes (e.g., tonnage yield from various production runs in a steelmaking furnace for a particular variety of steel). Other types of data gathered may include cost data and cost driver data, such as gas mileage realized by trucks transporting certain tonnage loads of steel between plants, labor costs relating to the truck driver and the loading and unloading crews, insurance costs relating to the truck fleet, etc. The data may be gathered into one or more spreadsheets, databases, flat or formatted text files, or other known data storage and formatting scheme.

At step 302, one of the one or more models is selected for use in forming a scenario to be optimized. The selected model is combined with the collected data to form the scenario. The model includes variables representing, abstractly, quantities and values associated with various aspects of the processes and costs represented by the model. The data are connected to the model to provide concrete numerical values to the variables of the model based on real-world observation, scientific simulation, educated estimation by technical experts, etc.

Scenarios constructed at step 302 can be defined as “accounting” or “regular.” “Accounting scenarios” are created by the organization primarily for analyzing actual performance of the organization over a period, and for validating calculations produced by the system by comparing reports from such scenarios (“actual scenarios”) to official profit and loss statements and other existing financial metrics. Accounting scenarios are intended to be directly used with the existing cost accounting data of the organization. Accounting scenarios allow absolute dollars for cost elements (such data is often readily available in the industry), and also allow accounting for inventory buildup and consumption following the principles adopted by the organization, through differentiation between production and sales volumes. “Regular scenarios” on the other hand are primarily intended for what-if analysis and allow only a very simple treatment of inventory, therefore allowing flexible analysis of profitability by allowing the user to change the data freely without addressing how the change will affect the inventory.

The connection of data and model result in a “scenario,” which can be processed by the ABC analyzer and over which the linear programming optimization can be performed if required. A scenario is thus a complete simulated description of the enterprise, including processes, process flows, and data corresponding to various costs, settings, cash flows, time restraints, production capacities, and the like that comprise the total operations of the enterprise. Various elements of the scenario may be deemed “parameters,” in that they are values that may be modified as part of an enterprise optimization. Some examples of adjustable parameters may include production volumes of specific products at specific mills, in specific furnaces. It may be possible to shift production from one plant to another, to reduce production of one product and increase another, etc. Other elements of the scenario may be deemed “constraints,” which are inelastic and cannot be changed beyond certain limits. These may be absolute requirements, such as the number of hours during which a machine is available for operation in a period. Other constraints may be expressible as limits, or inequalities, such as a maximum tonnage load that a truck may carry, where the truck is also capable of carrying a smaller load than the maximum.

At step 303, some of the data points of the scenario optionally are adjusted to provide a “what-if” version of the enterprise and its operation.

At step 304, constraints with ranges are given initial values for processing. There may be average values within the permissible range or another value within the range. Numerics are given to the parameters if not already assigned or input.

At step 305, assurance is made that each product is run through each process/activity path so all potential outcomes are considered. This process facilitates the availability of adequate and correct data for input to ABC1. This step may include selecting or confirming parameter and/or constraint values and may be done manually or via enterprise resource planning (ERP) or management resource planning (MRP) or other systems.

At step 306, the scenario formed in steps 302 and 303 and confirmed in steps 304 and 305 is delivered to the profitability and cost engine 225 to produce profitability and cost reports and dashboards for consumption by the user. Among other considerations, the products of ABC1 process of step 306 permit pre-optimization review of costing data to improve accuracy and sufficiency, etc., so that the optimization process proceeds with enhance probability of achieving a “feasible” outcome.

Sources of data may include manual entry and system-based data gathering, among others, both of which are subject to the introduction of errors. Furthermore, data will typically be updated at regular intervals (with new cost information, performance data, etc.,), typically quarterly if not more often. This is generally referred to as “data maintenance.” Each update is become an opportunity for the introduction of erroneous data. Thus, the output of ABC1 provides for review and correction of erroneous data from these large organizational data sets, prior to profit optimization.

At step 307, optionally one or more constraints of the scenario are changed to generate a scenario with updated constraints. These changes may be due to new data, the discovery of erroneous data, the desire to investigate other constraints, or for other reasons.

At step 309, the scenario is delivered to a linear programming analyzer for optimization. The input to the analyzer also includes a objective function to be optimized. In some cases, the objective function may be overall profit realized by the enterprise, and the optimizer will solve for the solution that maximizes profit. In other cases, an optimization may be performed over other objective functions, such as total sales volume or total revenues, which would be maximized, or objective functions such as total expenses and liabilities, which would be minimized.

The scenario provides values of parameters and constraints to the linear programming analyzer together with the objective function, thus defining a linear programming problem that can be solved according to known methods. In some embodiments, the linear programming analyzer may be an off the shelf tool such as Microsoft Solver Foundation, OpenOpt, LP_Solve, CPLEX, MATLAB or Mathematica. In some embodiments, custom software may be designed to perform a linear programming optimization on scenarios as provided according to described embodiments. The linear programming optimization solves for values for the adjustable parameters that result in the optimal simulated value of the objective function, subject to the defined constraints, and returns a scenario including these optimized values of the parameters.

At step 309, a user is able to perform multiple round(s) of optimization in which the user chooses at least one constraint of the input scenario to be modified. In one example, sales volumes of one or more product groups may be relaxed, e.g., by 10%. This adjustment would allow the user to perform a “what-if” analysis of how changing economic and business conditions, leading to a reduction or growth in sales, could be met to optimize profit under the changed circumstances. For example, in a situation where sales lag, it may be more efficient to consolidate production in a single production facility and to shut down or reduce output at another production facility. Similarly, a modified strategy for load-sharing of production demands may be a more optimal solution when sales pick up in response to improved economic conditions. Other “what-if” scenarios might reflect the possibility of upgrading facilities, such as by increasing production capacity at a particular plant, allowing for the possibility of shifting production demand. Alternative scenario analysis of this sort can also be employed to differentiate between actual realized performance of the enterprise and planned enterprise operations.

At step 310, the scenario or updated scenario is run through the ABC processing again. This process produces reports and dashboard indications that display corrected and optimized outcomes for use by a manufacturer or the like select the manufacturing path for each product that yields the best return.

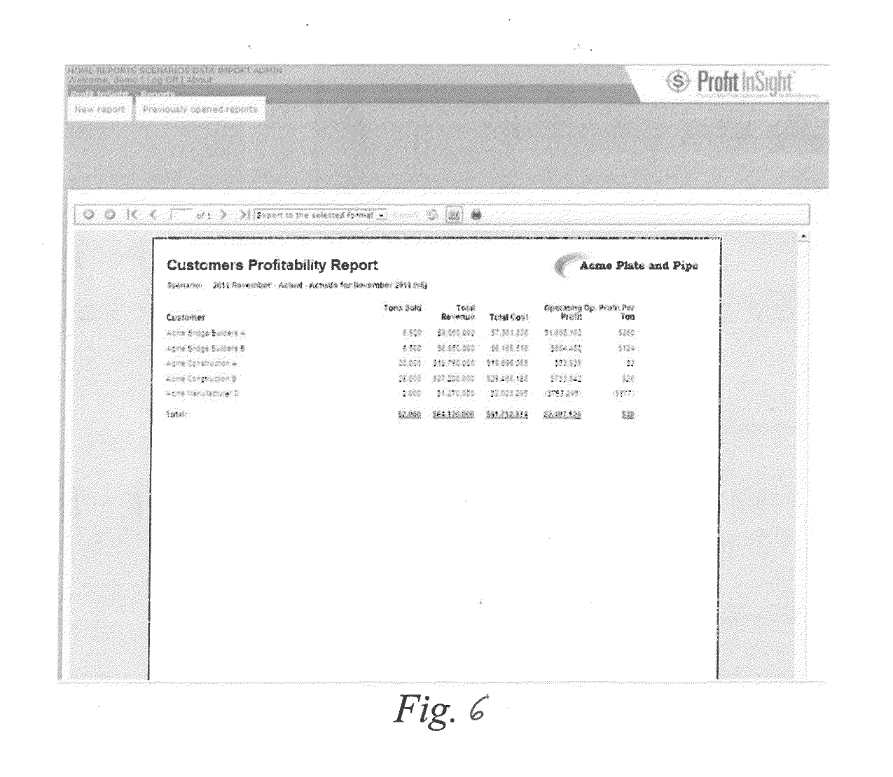

FIG. 6 is a screenshot of a report showing profitability by customer according to a scenario optimized by the profit analyzer of FIG. 2. In the left-most column of FIG. 6, various customers of the Acme Plate and Pipe enterprise are shown. The remaining columns list, for each of those customers, data relating to sales to the customer and profit corresponding to those sales.

The report also presents, in the bottom row, a summary of overall sales and profit data realized by the Acme Plate and Pipe enterprise aggregated across all of the displayed customers.

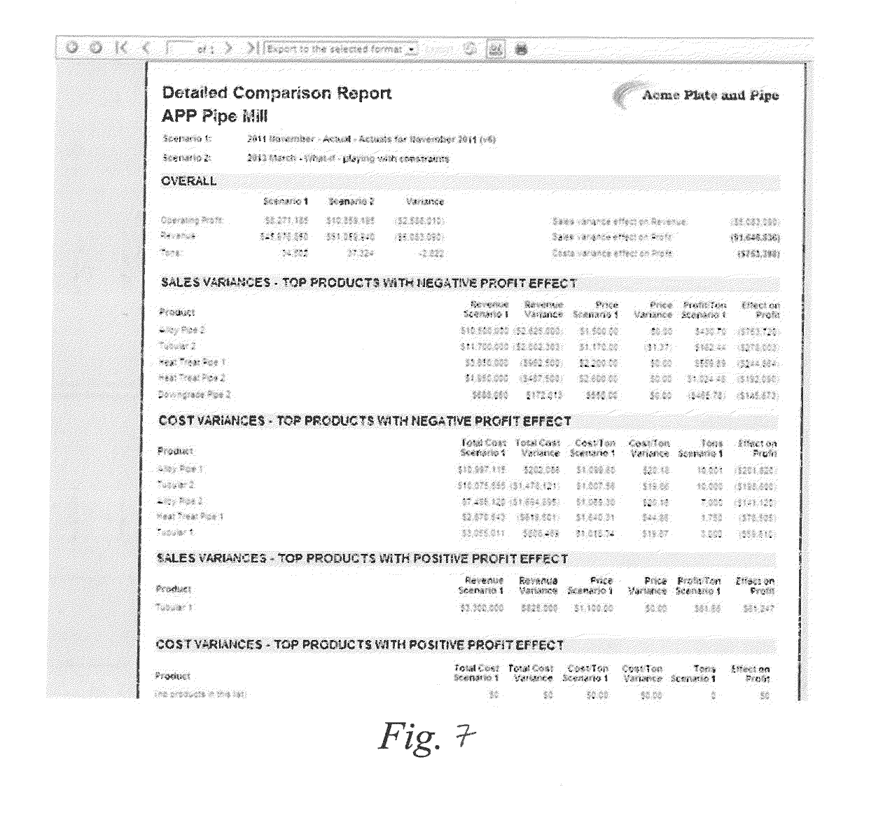

FIG. 7 is a screenshot of a report showing a comparison of revenue, cost and profit between two scenarios optimized by the profit analyzer of FIG. 2 for one of the divisions of the enterprise, namely the “pipe mill.” The report shows side-by-side, in the section entitled “OVERALL,” operating profit, revenue, and tons of steel sold in the two scenarios being compared, noting the difference (or “variance”) between the results of the two scenarios. There are variances in the sales between the two scenarios, in that more or less of individual products are sold. Each of these variances produces a certain effect on bottom line (total) profit per individual product (or per groups of products in other cases). The report lists products showing the largest negative and largest positive effect on profit caused by the corresponding variances in sales, therefore exposing which sales changes are effecting the bottom-line profitability the most. In a similar manner the sections of the report may list products with the variances in costs which cause the largest positive and largest negative effect on bottom-line profitability.

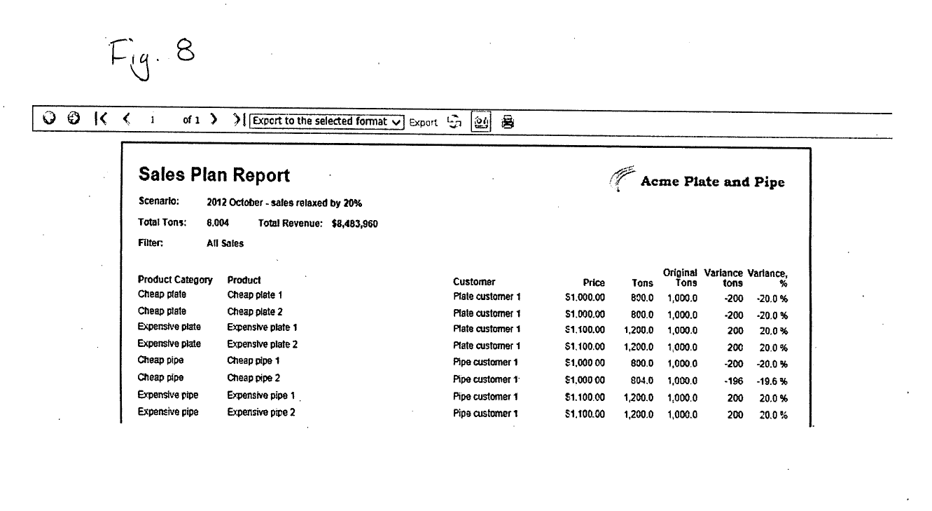

FIG. 8 is a screenshot of a report showing an optimized sales plan resulting from optimization of a scenario by the profit analyzer of FIG. 2. The report provides, on each line, a proposed plan for selling a specific amount of a specific product to a specific client. The values in the report represent the proposed sales to realize optimized profit for the selected scenario, as calculated by the profit analyzer of FIG. 2.

While activity based costing and linear optimization are discussed above as preferred processing tools, it should be recognized that other costing and optimization tools may be used without departing from the present invention. Attributes of suitable costing tools include their ability to deliver results in reports or dashboards that are user-friendly for application to an enterprise and sufficiently accurate. Similarly, suitable optimization programs will be able to achieve optimum processing/activity paths for a plurality of products passing through a plurality of process steps or paths.

Suitable alternative costing and/or optimization methodologies, whether known now or later develop, are considered to be tools within the combined costing and optimization steps of the present invention.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features herein before set forth, and as fall within the scope of the invention and the limits of the appended claims.

1. A machine-executible method for enterprise profit optimization, comprising the steps of:
inputting an enterprise profit optimization model and gathered data for at least a first product;
creating an enterprise profit optimization scenario for at least a first product from the model and gathered data;
executing a first activity based costing (ABC) process on the optimization scenario to a produce a first ABC output;
executing a linear optimization process on the first ABC output to produce an optimized processing path output for at least the first product; and
executing a second activity based costing (ABC) process on the optimized processing path output to produce data signals representative of a profit optimized solution for the first product.

2. The method of claim 1, further comprising the steps of:
inputting an enterprise profit optimization model and gathered data for a plurality of products;
creating and enterprise profit optimization scenario for the plurality of products;
executing the first ABC process, the linear optimization process and the second ABC process to produce data signals representative of a profit optimized solution for the plurality of products.

3. The method of claim 1, wherein the plurality of products is 10 products or more.

4. The method of claim 1, wherein the plurality of products is 50 products or more.

5. The method of claim 1, wherein the step of executing a second ABC process to profit optimized solution includes the step of producing one or more of a manufacturing profit optimized solution and a marketing optimized solution for the at least one product.

6. The method of claim 1, further comprising the step of modifying the first ABC output before the linear optimization process to facilitate producing, in the linear optimization process, a optimized processing path output that is feasible.

7. The method of claim 1, further comprising the step of updating the content of the gathered data.

8. The method of claim 2, further comprising the step of validating parameters and constraints values to be used in the optimization scenario for the plurality of products.

9. The method of claim 2, further comprising the step of assuring for integration into the optimization scenario, that each of the plurality of products is run through the potential manufacturing processes and activities so that the various process paths for each of the plurality of produces is considered in the first ABC, linear optimization and second ABC process and thereby included in the profit optimized solution for the plurality of products.

10. The method of claim 2, wherein the profit optimized solution on the second ABC process includes at least one of reports and dashboards that display profitability plans for the plurality of products.

11. A computer-based system for enterprise profit optimization, the system comprising:
a storage device to
receive, at the computer, an enterprise profit optimization model;
receive, at the computer, gathered data for the model, including one or more of costing data, manufacturing expenses, raw material rates, utility costs, delivery costs, labor costs, and over head costs; and
a processor to
create a profit optimization scenario from the model and gathered data for a plurality of products;
execute a first activity based costing (ABC) process on the profit optimization scenario;
execute a linear optimization process on the output of the first ABC process; and
execute a second ABC process on the output of the linear optimization process and produce signals represented of a profitability plan therefrom.

12. The system of claim 11, wherein the processor modifies the first ABC output before the linear optimization process to facilitate producing, in the linear optimization process, a optimized processing path output that is feasible.

13. The system of claim 11, wherein the processor validates parameters and constraints values to be used in the optimization scenario for the plurality of products.

14. The system of claim 11, wherein the processor assures that each of the plurality of products is run through the potential manufacturing processes and activities for that product so that the various process paths for each of the plurality of produces is considered in the first ABC, linear optimization and second ABC process and thereby included in the profit optimized solution for the plurality of products.

15. The system of claim 11, wherein the plurality of products is 20 or more products.
